(19) United States
(12) Patent Application Publication
(10) Pub. No.: US 2025/0174402 A1
(43) Pub. Date: May 29, 2025

(54) DIELECTRIC CERAMIC AND CERAMIC CAPACITOR USING THE SAME

(71) Applicant: Murata Manufacturing Co., Ltd., Nagaokakyo-shi (JP)

(72) Inventors: Takashi TERANISHI, Nagaokakyo-shi (JP); Keisuke NOMURA, Nagaokakyo-shi (JP); Jun IKEDA, Nagaokakyo-shi (JP)

(21) Appl. No.: 19/027,561

(22) Filed: Jan. 17, 2025

Related U.S. Application Data
(63) Continuation of application No. PCT/JP2023/042228, filed on Nov. 24, 2023.

(30) Foreign Application Priority Data
Feb. 28, 2023 (JP) 2023-030206

(51) Int. Cl. H01G 4/12; C04B 35/495; H01G 4/30

(52) U.S. Cl. CPC H01G 4/1254; C04B 35/495; C04B 2235/3253; H01G 4/30

(57) ABSTRACT

A dielectric ceramic having: a rutile compound represented by (TiₓSn₁₋ₓ)O₂ as a main constituent; and Nb, wherein 0.40≤x≤0.60, and in a sectional view the dielectric ceramic includes: a Ti-rich phase region in which A is 0.55 or more, a Sn-rich phase region in which B is 0.55 or more, A=(Ti content (atom %))/(total content of Ti and Sn (atom %)), B=(Sn content (atom %))/(total content of Ti and Sn (atom %)), 0.005 mol %≤y≤0.020 mol %, 16 nm≤D_{Ti}≤20 nm, 15 nm≤D_{Sn}≤19 nm, wherein y (mol %) is a content of Nb with respect to 100 mol % of a content of the rutile compound, D_{Ti} (nm) is an average size of the Ti-rich phase region, and D_{Sn} (nm) is an average size of the Sn-rich phase region.

### CROSS REFERENCE TO RELATED APPLICATIONS

The present application is a continuation of International application No. PCT/JP2023/042228, filed Nov. 24, 2023, which claims priority to Japanese Patent Application No. 2023-030206, filed Feb. 28, 2023, the entire contents of each of which are incorporated herein by reference.

### TECHNICAL FIELD

The present disclosure relates to a dielectric ceramic and a ceramic capacitor using the dielectric ceramic.

### BACKGROUND ART

When the Ti_{0.5}Sn_{0.5}O₂ ceramic, a metastable phase, is heated and then quenched, the phase is separated into a phase having a large Ti content (Ti-rich phase) and a phase having a large Sn content (Sn-rich phase) through spinodal decomposition to form a stripe structure having a width of 10 to 100 nm.

When the Ti_{0.5}Sn_{0.5}O₂ ceramic is added with Nb as a donor, electrons are generated as a carrier. When the Nb-added ceramic is heated to cause spinodal decomposition, electrons are blocked by the barrier between the Ti-rich phase and the Sn-rich phase, so that the ceramic has a high permittivity (for example, Non-Patent Document 1).

Non-Patent Document 1: W. Chaisan et al., “The effects of the spinodal microstructure on the electrical properties of TiO₂-SnO₂ ceramics”, Journal of Solid State Chemistry 178 (2005) 613-620

### SUMMARY OF THE DISCLOSURE

A ceramic material used for an electronic component, particularly a ceramic material used for a ceramic capacitor, is desired to have both a high relative permittivity and a low dielectric loss tangent. For example, a ceramic material having a dielectric loss tangent of 0.035 or less at 10 kHz and a relative permittivity of 2400 or more is required.

However, the ceramic material disclosed in Non-Patent Document 1 cannot achieve both a low dielectric loss tangent and a high relative permittivity.

Therefore, an object of the present disclosure is to provide a dielectric ceramic capable of achieving both a low dielectric loss tangent and a high relative permittivity, and to provide a ceramic capacitor using the dielectric ceramic.

One gist of the present disclosure provides a dielectric ceramic having: a rutile compound represented by (TiₓSn₁₋ₓ)O₂ as a main constituent; and Nb, wherein 0.40 ≤x ≤0.60, and in a sectional view the dielectric ceramic includes: a Ti-rich phase region in which A is 0.55 or more, a Sn-rich phase region in which B is 0.55 or more, A=(Ti content (atom %))/(total content of Ti and Sn (atom %)), B=(Sn content (atom %))/(total content of Ti and Sn (atoms)), 0.005 mol %≤y≤0.020 mol %, 16 nm≤D_{Ti}≤20 nm, 15 nm≤D_{Sn}≤19 nm, wherein y (mol %) is a content of Nb with respect to 100 mol % of a content of the rutile compound, D_{Ti} (nm) is an average size of the Ti-rich phase region, and D_{Sn} (nm) is an average size of the Sn-rich phase region.

Another gist of the present disclosure provides a ceramic capacitor having a ceramic body including the dielectric ceramic of the present disclosure.

Still another gist of the present disclosure provides a multilayer ceramic capacitor having a ceramic body including the dielectric ceramic of the present disclosure.

According to the present disclosure, it is possible to provide a dielectric ceramic capable of achieving both a low dielectric loss tangent and a high relative permittivity, and to provide a ceramic capacitor using the dielectric ceramic.

### BRIEF EXPLANATION OF THE DRAWINGS

FIG. 1 is a schematic view for illustrating the internal structure in a sectional view of a dielectric ceramic according to Embodiment 1 of the present disclosure.

FIG. 2 shows a STEM image of the section of a sample prepared in Example 1 of the present disclosure, and results of examining the distribution of each of Ti, Nb, and Sn from a TEM image by EDX analysis.

FIG. 3 shows results of the distribution of the Ti-rich phase and the Sn-rich phase obtained by using the distribution results of Ti and Sn that are examined by EDX-analyzing a TEM image of the section of a sample prepared in Example 1 of the present disclosure.

FIG. 4 is a schematic sectional view of a multilayer ceramic capacitor according to Embodiment 2.

### DETAILED DESCRIPTION OF THE PREFERRED EMBODIMENTS

The Ti_{0.5}Sn_{0.5}O₂ ceramic disclosed in Non-Patent Document 1 is difficult to achieve a low dielectric loss tangent. The reason is not clear, but is presumed as follows.

The Ti_{0.5}Sn_{0.5}O₂ ceramic forms a stripe structure of the Ti-rich phase and the Sn-rich phase through spinodal decomposition. The stripe structure extends in one direction in one crystal grain. The stripe structure extends in one direction also in another crystal grain. However, the extending direction does not necessarily coincide with the extending direction in an adjacent crystal grain. It is difficult to control the direction of phase separation occurring in a crystal grain. Therefore, it is also difficult to intentionally align the extending direction of the stripe structure or intentionally change the extending direction between adjacent crystal grains.

Crystal grains constituting a ceramic have grain boundaries between adjacent crystal grains. Each of the Ti-rich phase and the Sn-rich phase constituting the stripe structure in a crystal grain extends in a thin band state and terminates at a grain boundary with an adjacent crystal grain. When the end of each rich phase located at a grain boundary comes into contact with the end of the same kind of rich phase in an adjacent crystal grain, a current path may be formed between the adjacent crystal grains.

For example, when the end of a Ti-rich phase in a certain crystal grain and the end of a Ti-rich phase in an adjacent crystal grain are in contact with each other at the grain boundary, electrons can flow from the Ti-rich phase in one crystal grain to the Ti-rich phase in the other crystal grain through the grain boundary when a voltage is applied to the ceramic.

Similarly, when the end of a Sn-rich phase in a certain crystal grain and the end of a Sn-rich phase in an adjacent crystal grain are in contact with each other at the grain boundary, electrons can flow from the Sn-rich phase in one crystal grain to the Sn-rich phase in the other crystal grain through the grain boundary when a voltage is applied to the ceramic.

As described above, a ceramic in which electrons can move between adjacent crystal grains has a problem that the dielectric loss tangent increases.

As a result of intensive studies, the present inventors have found that the Ti-rich phase and the Sn-rich phase generated by spinodal decomposition can be controlled to have an island shape by controlling the heating condition during firing the ceramic. In the dielectric ceramic having an island structure, a current path is hardly formed between adjacent crystal grains. Therefore, both a low dielectric loss tangent and a high relative permittivity can be achieved.

Hereinafter, the dielectric ceramic according to an embodiment of the present disclosure and the ceramic capacitor using the dielectric ceramic will be described in detail.

### Embodiment 1

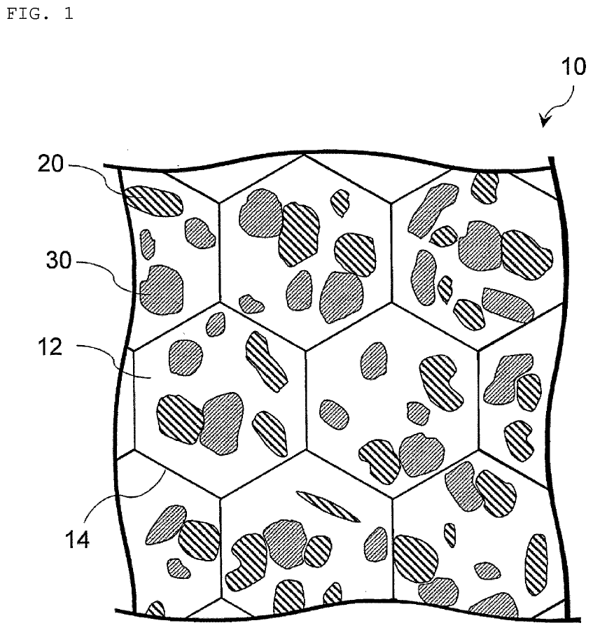

FIG. 1 is a schematic view for illustrating the internal structure in a sectional view of a dielectric ceramic according to Embodiment 1.

A dielectric ceramic 10 has a formulation including a rutile type compound represented by (TiₓSn₁₋ₓ)O₂ (0.40≤x≤0.60) as a main constituent, and further including Nb. The dielectric ceramic 10 includes a large number of crystal grains 12 and grain boundaries 14 present between the crystal grains 12 therein.

In a sectional view, the dielectric ceramic 10 includes a region made of a Ti-rich phase (Ti-rich phase region 20) in which A defined by a formula (1) below is 0.55 or more; and a region made of a Sn-rich phase (Sn-rich phase region 30) in which B defined by a formula (2) below is 0.55 or more in each of the crystal grains 12. In the crystal grain 12, the region that is neither the Ti-rich phase region 20 nor the Sn-rich phase region 30 is a ceramic phase in which A is less than 0.55 and B is less than 0.55 (That is, the Ti content and the Sn content are about the same.).

$$A = ( Ti content ( atom \% ) ) / ( total content of Ti and Sn ( atom \% ) ) \qquad ( 1 )$$

$$B = ( Sn content ( atom \% ) ) / ( total content of Ti and Sn ( atom \% ) ) \qquad ( 2 )$$

The Ti content (atom %) and the Sn content (atom %) at each measurement position can be measured by STEM-EDX (acceleration voltage: 200 kV, magnification: 60,000 times).

The dielectric ceramic 10 further satisfies the following formulas (3) to (5).

$$0.005 mol \% \leq y \leq 0.02 mol \% \qquad ( 3 )$$

$$16 nm \leq {D}_{Ti} \leq 20 nm \qquad ( 4 )$$

$$15 nm \leq {D}_{Sn} \leq 19 nm \qquad ( 5 )$$

wherein y (mol %) is a content of Nb with respect to 100 mol % of a content of the rutile type compound,

D_{Ti} (nm) is an average size of a Ti-rich phase region, and

D_{Sn} (nm) is an average size of a Sn-rich phase region.

The formula (3) defines the Nb (donor) content in the dielectric ceramic 10. By appropriately controlling the Nb content, both a low dielectric loss tangent and a high relative permittivity can be achieved.

The Nb content (mol %) can be measured by composition analysis using Inductively Coupled Plasma Atomic Emission Spectroscopy.

The formula (4) defines the average size of the Ti-rich phase region 20, and the formula (5) defines the average size of the Sn-rich phase region 30.

The average size is determined by the following procedure.

The dielectric ceramic is observed by STEM-EDX (acceleration voltage: 200 kV, magnification: 60,000 times), and the Ti-rich phase region 20 and the Sn-rich phase region 30 are specified from the obtained data of the content of each element. With an image analysis software (for example, image analysis software winROOF (MITANI CORPORATION)), 300 regions are arbitrarily selected for each of the rich phase regions in the observation area, and each maximum size is measured (Feret's II diameter (horizontal)). The average values of the obtained measurement data of the maximum size (300 data for each rich phase region) are calculated and defined as “average size D_{Ti} (nm) of the Ti-rich phase region 20” and “average size D_{Sn} (nm) of the Sn-rich phase region 30”. When less than 300 regions are included in one visual field observation for each of the rich phase regions, visual field observation is performed two or more times, 300 rich phase regions are selected, and the size is measured.

In the dielectric ceramic 10 according to Embodiment 1, the average size D_{Ti} (nm) of the Ti-rich phase region 20 is controlled in 16 nm≤D_{Ti}≤20 nm, and the average size D_{Sn} (nm) of the Sn-rich phase region 30 is controlled in 15 nm≤D_{Sn} ≤19 nm. Each of the rich phase regions 20 and 30 whose size is controlled in this manner has an island structure having a certain size, and as a result, the dielectric ceramic 10 can achieve both a low dielectric loss tangent and a high relative permittivity.

When the dielectric ceramic 10 includes a Ti-rich phase having a stripe structure, the Ti-rich phase having a stripe structure has a maximum size much larger than the maximum size of a Ti-rich phase having an island structure, and presumably the average size D_{Ti} (nm) of the Ti-rich phase region 20 exceeds 20 nm.

Similarly, when the dielectric ceramic 10 includes a Sn-rich phase having a stripe structure, the Sn-rich phase having a stripe structure has a maximum size much larger than the maximum size of a Sn-rich phase having an island structure, and presumably the average size D_{Sn} (nm) of the Sn-rich phase region 30 exceeds 19 nm.

Preferably, the average size D_{Ti} of the Ti-rich phase region is 16 nm to 18 nm. More preferably, the average size D_{Ti} of the Ti-rich phase region is 16 nm to 17 nm. The obtained dielectric ceramic 10 can achieve both a lower dielectric loss tangent and a higher relative permittivity.

In a sectional view, the Ti-rich phase region preferably has an area ratio α (%) of 5.50% to 7.10% when the dielectric ceramic excluding pores has an area ratio of 100%. The obtained dielectric ceramic 10 can achieve both a lower dielectric loss tangent and a higher relative permittivity.

More preferably, the area ratio α (%) is 5.50% to 6.80%. The obtained dielectric ceramic 10 can achieve both a still lower dielectric loss tangent and a still higher relative permittivity.

The phrase “the dielectric ceramic excluding pores has an area ratio of 100%” means that the data of the content of each element obtained by the above-described STEM-EDX measurement is subjected to image analysis, the area of the observation visual field is subtracted with the area of pores, and the obtained area is 100%. The term “pores” refers to hollow portions present in the dielectric ceramic.

The method of identifying the pores by image analysis is as follows. The Ti distribution image and the Sn distribution image acquired from the same observation site are prepared. The Ti distribution image is analyzed to specify the highest Ti detection intensity in the visual field and specify the entire region with a Ti detection intensity that is 1/100 or less of the highest detection intensity (low Ti concentration region). Similarly, the Sn distribution image is analyzed to specify the highest Sn detection intensity in the visual field and specify the entire region with a Sn detection intensity that is 1/100 or less of the highest detection intensity (low Sn concentration region). The portion corresponding to both the low Ti concentration region and the low Sn concentration region is regarded as “pores”.

In the present specification, “area ratio α (%) of the Ti-rich phase region” is an area ratio obtained from the total area of the Ti-rich phase region in which the size of the continuous Ti-rich phase (that is, the maximum size of the Ti-rich phase region) is 14 nm or more in the observation visual field.

The above various measurements are performed in the central portion of the dielectric ceramic.

### Method for Producing Dielectric Ceramic

The dielectric ceramic according to Embodiment 1 includes the following steps 1) to 5).
1) Mixing raw materials containing Ti, Sn, and Nb in a predetermined ratio
2) Calcining the mixed raw materials
3) Press-molding the calcined powder
4) Firing the molded body at a firing temperature higher than 1505° C. and lower than 1520° C. for a predetermined firing time
5) Quenching after firing

Embodiment 1 differs from Non-Patent Document 1 in the following.

Embodiment 1 employs a high firing temperature in step 4) (Non-Patent Document 1 employs a firing temperature of 1450° C.).

Embodiment 1 does not include annealing after step 5) (Non-Patent Document 1 includes annealing at 1000° C. for 1 to 48 hours after step 5).).

Hereinafter, the method for producing the dielectric ceramic according to Embodiment 1 will be described in detail.

### 1) Mixing Raw Materials Containing Ti, Sn, and Nb in a Predetermined Ratio

Raw materials serving as a Ti source, a Sn source, and a Nb source are blended so that the content of Ti, Sn, and Nb is in a desired ratio. As the raw material, oxides of Ti, Sn, and Nb can be used.

The raw materials blended at a predetermined ratio are mixed using an apparatus such as a ball mill, a high-pressure dispersion, or a jet mill. Both dry mixing and wet mixing can be applied. In the wet mixing, an organic solvent such as ethanol, an inorganic solvent such as water, or the like is preferably used as the solvent.

### 2) Calcining the Mixed Raw Materials

The mixed raw materials are dried and granulated to prepare a raw material powder. The raw material powder is calcined at 900° C. to 1400° C. for 1 hour to 24 hours to obtain a solid solution. The calcination is performed in air, in an oxygen atmosphere, or the like. For the calcination, an electric furnace or the like can be used.

### 3) Press-Molding the Calcined Powder

The calcined powder is granulated and molded into a predetermined size and shape. The molding is performed by uniaxial pressing, CIP, WIP, or the like. Further, two or more molding methods may be applied in order. For example, CIP may be applied after molding by uniaxial pressing.

### 4) Firing the Molded Body at a Firing Temperature Higher Than 1505° C. and Lower Than 1520° C. for a Predetermined Firing Time

The molded body is fired at a firing temperature higher than 1505° C. and lower than 1520° C. for 5 hours to 120 hours. Fired in this temperature range, the Ti-rich phase region and the Sn-rich phase region can be made into an island shape. The firing temperature is preferably 1510° C. or higher and 1515° C. or lower.

The firing is performed in air, in an oxygen atmosphere, or the like. For the firing, an electric furnace, a millimeter wave furnace, an infrared furnace, or the like can be used. The heating rate during heating is preferably 1° C./min to 30° C./min.

### 5) Quenching After Firing

After the firing is completed, the molded body is taken out from the furnace and quenched in air or water. Thus, a structure in which the Ti-rich phase region and the Sn-rich phase region are phase-separated in an island shape can be obtained inside the crystal grains.

### Embodiment 2

In Embodiment 2, a ceramic capacitor having a ceramic body including the dielectric ceramic according to Embodiment 1 will be described.

The ceramic capacitor includes those not having internal electrodes inside the ceramic element (single-layer ceramic capacitor) and those having a plurality of internal electrodes inside the ceramic element (multilayer ceramic capacitor).

The single-layer ceramic capacitor corresponds to a multilayer ceramic capacitor excluding internal electrodes. Therefore, the multilayer ceramic capacitor will be mainly described with reference to the drawing.

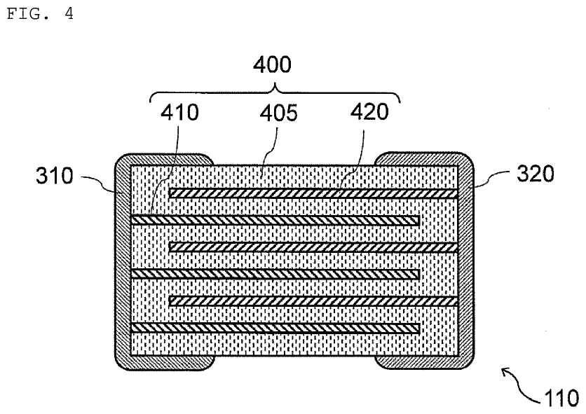

FIG. 4 is a schematic sectional view of a multilayer ceramic capacitor 110. The multilayer ceramic capacitor 110 includes a ceramic body 400 and external electrodes 310 and 320 provided at both ends of the ceramic body 400.

The ceramic body 400 is made of a plurality of ceramic layers 405. Internal electrodes 410 and 420 are provided inside the ceramic body 400. The internal electrodes 410 and 420 and the ceramic layers 405 are alternately laminated to constitute the ceramic body 400. The internal electrodes 410 and 420 are exposed from any one of the end surfaces of the ceramic body 400 and are electrically connected to the external electrodes 310 and 320.

The ceramic layer 405 of the ceramic body 400 used in the multilayer ceramic capacitor 110 is formed of the dielectric ceramic according to Embodiment 1. Therefore, the ceramic layer 405 has a high relative permittivity and a small dielectric loss tangent. Therefore, it is possible to obtain the multilayer ceramic capacitor 110 having a large electrical capacitance and little heat generation or the like due to dielectric loss.

As the materials of the external electrodes 310 and 320 and the internal electrodes 410 and 420 used in the multilayer ceramic capacitor 110, and the method for producing the multilayer ceramic capacitor 110, known materials for an external electrode and an internal electrode, and known methods for producing a multilayer ceramic capacitor can be used.

On the other hand, the single-layer ceramic capacitor uses a ceramic body including no internal electrodes, and is provided with external electrodes on both ends of the ceramic body.

The ceramic body used in the single-layer ceramic capacitor is formed of the dielectric ceramic according to Embodiment 1. Therefore, it is possible to obtain the single-layer ceramic capacitor having a large electrical capacitance and little heat generation or the like due to dielectric loss.

### EXAMPLES

### A) Preparation of Dielectric Sintered Body Sample

TiO₂, SnO₂, and Nb₂O₅ were used as raw materials. Each raw material was weighed so that the content of Ti, Sn and Nb was in the relationship of the content of each element shown in Table 1, an organic solvent such as ethanol was added, and wet mixing was performed for a predetermined time in a ball mill. Thereafter, the dried and granulated powder was calcined in air at 1100° C. for 6 hours to obtain a solid solution. This powder was granulated, press-molded at 20 MPa for 1 minute by uniaxial pressing using a 10 mφ molding machine, and further subjected to CIP treatment at 125 MPa for 1 minute to obtain a molded body.

This molded body was held in air at the firing temperature shown in Table 1 for 24 hours for firing to obtain a sample of a dense dielectric sintered body (hereinafter, sometimes referred to as “sintered body”). The temperature was raised for firing at a temperature rising rate of 5° C./min, and the temperature was lowered through quenching in air.

### B) Characterization

(1) Measurement of Average Size of Ti-Rich Phase Region and Sn-Rich Phase Region in Sintered Body Sample

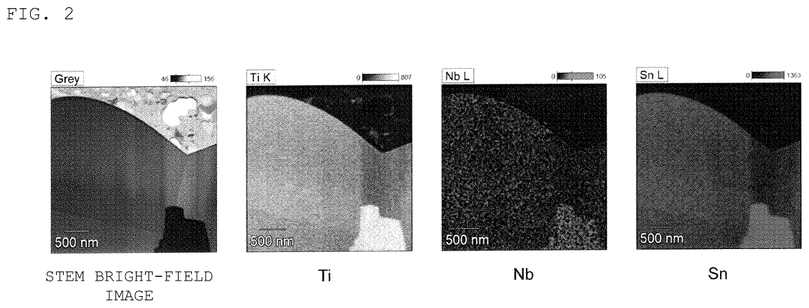

The sintered body sample is filled in a resin in a state where the entire outer surface of the sintered body sample is covered with an epoxy resin. After the epoxy resin was cured, the sample was mirror-polished together with the epoxy resin. Thereafter, a piece with a thickness of 80 to 1200 nm was cut out with FIB, and sputtered with Pt. Ti, Sn, and Nb (atom %) in the sintered body sample were measured by STEM-EDX. STEM observation was performed at a magnification of 60,000 times at an acceleration voltage of 200 kV (FIG. 2). The distribution data of each element (FIG. 2) obtained through STEM-EDX was subjected to image processing and a csv file with 256 cells×256 cells was output. Each cell is filled with a value of the content (atom %) of each element at the measurement point corresponding to the cell position. Using the Ti distribution data (csv file of Ti content (atom %)) and the Sn distribution data (csv file of Sn content (atom %)), the value of A was calculated through the following formula (1) at the measurement positions corresponding to each cell, and the value of B was calculated through the following formula (2) at the measurement positions corresponding to each cell.

$$A = ( Ti content ( atom \% ) ) / ( total content of Ti and Sn ( atom \% ) ) \qquad ( 1 )$$

$$B = ( Sn content ( atom \% ) ) / ( total content of Ti and Sn ( atom \% ) ) \qquad ( 2 )$$

Using spreadsheet software Excel (Microsoft Corporation), mapping data (Ti mapping data) including the calculation result (A value) from the formula (1) filled in a range of 256 cells×256 cells and mapping data (Sn mapping data) including the calculation result (B value) from the formula (2) filled in a range of 256 cells×256 cells were created.

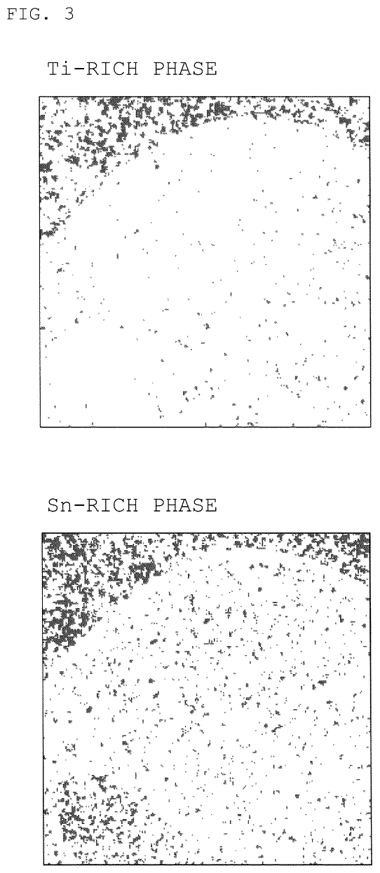

For the Ti mapping data, the ruled lines of Excel were hidden, and the character color filled in each cell was set to white. Further, the function of Excel “conditional format” was applied, and the background color and the character color were set to the same color (for example, red) in the cells having an A value of 0.55 or more. After the data was processed in this manner, the range of 256 cells×256 cells filled with numerical values was stored as image data (jpg file) (FIG. 3).

Similarly, for the Sn mapping data, the ruled lines of Excel were hidden, and the character color filled in each cell was set to white. Further, the function of Excel “conditional format” was applied, and the background color and the character color were set to the same color (for example, red) in the cells having a B value of 0.55 or more. After the data was processed in this manner, the range of 256 cells×256 cells filled with numerical values was stored as image data (jpg file) (FIG. 3).

When the value of A was 0.55 or more (A≥0.55), the measurement position was determined as the “Ti-rich phase”, and when the value of B was 0.55 or more (B≥0.55), the measurement position was determined as the “Sn-rich phase”. That is, in the Ti image data created by processing the Ti mapping data, the colored portion (for example, the red portion) indicates that the portion is the Ti-rich phase. Similarly, in the Sn image data created by processing the Sn mapping data, the colored portion (for example, the red portion) indicates that the portion is the Sn-rich phase.

The Ti image data was read in image analysis software winROOF (MITANI CORPORATION) to specify the highest Ti detection intensity in the visual field and specify the entire region with a Ti detection intensity that is 1/100 or less of the highest detection intensity (low Ti concentration region). Also, the Sn image data is analyzed in the same manner to specify the entire region with a Sn detection intensity that is 1/100 or less of the highest Sn detection intensity (low Sn concentration region). The portion corresponding to both the low Ti concentration region and the low Sn concentration region was specified as “pores”.

The Ti image data was analyzed again, and a file (roi file) in which the portion excluding pores was designated as “region for analysis” was created. Also, the Sn image data was analyzed again in the same manner to create a roi file.

For the roi file of the Ti image, clusters of red portions were regarded as a Ti-rich phase region. The Ti-rich phase region has an island shape. Three hundred regions were arbitrarily selected for the Ti-rich phase region in the observation area, and the maximum size for each region was measured (Feret's II diameter (horizontal)). The average value of the obtained measurement data of the maximum size (300 data) was defined as “average size D_{Ti} (nm) of the Ti-rich phase region”.

Similarly, for the roi file of the Sn image, clusters of red portions were regarded as a Sn-rich phase region. The Sn-rich phase region also has an island shape. Three hundred regions were arbitrarily selected for the Sn-rich phase region in the observation area, and the maximum size for each region was measured (Feret's II diameter (horizontal)). The average value of the obtained measurement data of the maximum size (300 data) was defined as “average size D_{Sn} (nm) of the Sn-rich phase region”.

In addition, in the roi file of the Ti image, the total area of the Ti-rich phase region (the total area of the entire Ti-rich phase region included in the observation area) was determined, and the area ratio of the total area of the Ti-rich phase region was determined when the area of “region for analysis” was 100%. The measurement target was the Ti-rich phase regions having a maximum size of 14 nm or more in the observation visual field.

Ten roi files of Ti images created from data measured at other positions through STEM-EDX were prepared. The area ratio of the total area of the Ti-rich phase region was determined for each file. The average value thereof was defined as the “area ratio α (%) of the Ti-rich phase region”.

### (2) Composition Analysis of Dielectric Sintered Body

The formulation of the sintered body sample was analyzed using Inductively Coupled Plasma Atomic Emission Spectroscopy. In order to quantify each element, a standard solution was used, a calibration curve was prepared in a range of the known concentration, and the sample concentration was relatively determined.

### (3) Measurement of Electrical Characteristics

Both surfaces of the sintered body sample were mirror-polished and then sputtered to form electrodes. The sintered body sample was measured for the electrostatic capacity and the dielectric loss tangent (dielectric loss). The measurement method was in accordance with JIS C 5101-1:2019(4.7.1) and JIS C 5101-1:2019(4.8.1). The measurement frequency was 10 kHz.

From the measurement result of the electrostatic capacity, the relative permittivity of the sintered body sample was calculated.

Evaluation criteria of electrical characteristics were as follows.

In the measurement at 10 kHz, those having a dielectric loss tangent of 0.035 or less and a relative permittivity of 2400 or more were rated as “pass (D)”. Those having a dielectric loss tangent of 0.030 or less and a relative permittivity of 2500 or more were rated as “C”, those having a dielectric loss tangent of 0.025 or less and a relative permittivity of 2550 or more were rated as “B”, and those having a dielectric loss tangent of 0.020 or less and a relative permittivity of 2600 or more were rated as “A”. Those lacking at least one of a dielectric loss tangent of more than 0.035 and a relative permittivity of less than 2400 were rated as “fail (F)”.

The measurement results are shown in Table 1.

TABLE 1

| | | | | | | | Sn-rich |
|---|---|---|---|---|---|---|---|
| | | | | | Ti-rich phase | | phase |
| | | | Nb | | region | | region |
| | Ti | Sn | Y | Firing | Average | Area | Average |
| | X | 1-x | (mol | temperature | size | ratio | size |
| No. | (atm %) | (atm %) | %) | (° C.) | D_{Ti} (nm) | α (%) | D_{Sn} (nm) |
| 1 | 0.498 | 0.502 | 0.010 | 1400 | 100.6 | 48.02 | 93.1 |
| 2 | 0.501 | 0.499 | 0.010 | 1450 | 61.1 | 26.69 | 53.0 |
| 3 | 0.502 | 0.498 | 0.011 | 1500 | 27.6 | 12.10 | 27.3 |
| 4 | 0.500 | 0.500 | 0.010 | 1505 | 22.9 | 9.04 | 22.9 |
| 5 | 0.497 | 0.503 | 0.011 | 1510 | 19.2 | 7.23 | 18.4 |
| 6 | 0.499 | 0.501 | 0.009 | 1515 | 16.2 | 5.73 | 15.1 |
| 7 | 0.548 | 0.452 | 0.011 | 1520 | 20.5 | 7.85 | 14.5 |
| 8 | 0.587 | 0.413 | 0.012 | 1525 | 25.5 | 10.33 | 14.3 |
| 9 | 0.391 | 0.609 | 0.010 | 1510 | 14.5 | 4.88 | 20.4 |
| 10 | 0.425 | 0.575 | 0.011 | 1510 | 16.2 | 5.73 | 18.2 |
| 11 | 0.484 | 0.516 | 0.010 | 1510 | 17.6 | 6.42 | 18.1 |
| 12 | 0.515 | 0.485 | 0.010 | 1510 | 18.2 | 6.72 | 16.5 |
| 13 | 0.558 | 0.442 | 0.010 | 1510 | 18.8 | 7.01 | 16.1 |
| 14 | 0.612 | 0.388 | 0.010 | 1510 | 19.3 | 7.26 | 15.4 |
| 15 | 0.499 | 0.501 | 0.003 | 1510 | 19.1 | 7.16 | 18.3 |
| 16 | 0.502 | 0.498 | 0.005 | 1510 | 18.7 | 6.96 | 18.0 |
| 17 | 0.501 | 0.499 | 0.008 | 1510 | 18.4 | 6.81 | 18.1 |
| 18 | 0.500 | 0.500 | 0.013 | 1510 | 18.5 | 6.86 | 18.8 |
| 19 | 0.501 | 0.499 | 0.016 | 1510 | 18.9 | 7.06 | 17.6 |
| 20 | 0.499 | 0.501 | 0.019 | 1510 | 19.0 | 7.11 | 17.4 |
| 21 | 0.499 | 0.501 | 0.022 | 1510 | 18.9 | 7.06 | 18.0 |

| | Relative | Dielectric | | |
|---|---|---|---|---|
| | permittivity | loss tangent | | |
| No. | (@10 kHZ) | (@10 kHZ) | Rating | |
| 1 | 243 | 0.251 | F | Comparative Example |
| 2 | 853 | 0.180 | F | Comparative Example |
| 3 | 2104 | 0.078 | F | Comparative Example |
| 4 | 2239 | 0.052 | F | Comparative Example |
| 5 | 2476 | 0.029 | D | Example |
| 6 | 2712 | 0.007 | A | Example |
| 7 | 2390 | 0.038 | F | Comparative Example |
| 8 | 2092 | 0.067 | F | Comparative Example |
| 9 | 1614 | 0.113 | F | Comparative Example |
| 10 | 2754 | 0.006 | A | Example |
| 11 | 2598 | 0.018 | B | Example |
| 12 | 2553 | 0.022 | B | Example |
| 13 | 2508 | 0.026 | C | Example |
| 14 | 1853 | 0.030 | F | Comparative Example |
| 15 | 1986 | 0.028 | F | Comparative Example |
| 16 | 2516 | 0.026 | C | Example |
| 17 | 2538 | 0.023 | C | Example |
| 18 | 2530 | 0.024 | C | Example |
| 19 | 2501 | 0.027 | C | Example |
| 20 | 2494 | 0.028 | D | Example |
| 21 | 2512 | 0.056 | F | Comparative Example |

Examples, each of which satisfies all the requirements specified in Embodiment 1, were favorable in relative permittivity and dielectric loss tangent, rated as A to D. Examples having an area ratio α (%) of the Ti-rich phase region of 5.50% to 7.10% were more favorable in relative permittivity and dielectric loss tangent, rated as C or higher. Furthermore, Examples having an area ratio α (%) of 5.50% to 6.80% and an average size D_{Ti} of the Ti-rich phase region of 16 nm to 18 nm were especially favorable in relative permittivity and dielectric loss tangent, rated as B or higher. In particular, Examples having an average size D_{Ti} of 16 nm to 17 nm were the most favorable in relative permittivity and dielectric loss tangent, rated as A.

Comparative Examples, each of which lacks at least one of the requirements specified in Embodiment 1, were rated F as at least one of the relative permittivity and the dielectric loss tangent was below the acceptable line.

The disclosure herein may include the following aspects.

<1> A dielectric ceramic having: a rutile compound represented by (TiₓSn₁₋ₓ)O₂ as a main constituent; and Nb, wherein 0.40≤x≤0.60, and, in a sectional view the dielectric ceramic includes: a Ti-rich phase region in which A is 0.55 or more, a Sn-rich phase region in which B is 0.55 or more, A=(Ti content (atom %))/(total content of Ti and Sn (atom %)), B=(Sn content (atom %))/(total content of Ti and Sn (atom %)), 0.005 mol %≤y≤0.020 mol %, 16 nm≤D_{Ti}≤20 nm, 15 nm≤D_{Sn}≤19 nm, wherein y (mol %) is a content of Nb with respect to 100 mol % of a content of the rutile compound, D_{Ti} (nm) is an average size of the Ti-rich phase region, and D_{Sn} (nm) is an average size of the Sn-rich phase region.

<2> The dielectric ceramic according to <1>, wherein, in the sectional view, the Ti-rich phase region has an area ratio α (%) of 5.50% to 7.10% when the dielectric ceramic excluding pores has an area ratio of 100%.

<3> The dielectric ceramic according to <2>, wherein the area ratio α (%) is 5.50% to 6.80%.

<4> The dielectric ceramic according to any one of <1> to <3>, wherein the average size D_{Ti} of the Ti-rich phase region is 16 nm to 18 nm.

<5> The dielectric ceramic according to any one of <1> to <4>, wherein the average size D_{Ti} of the Ti-rich phase region is 16 nm to 17 nm.

<6> A ceramic capacitor having a ceramic body including the dielectric ceramic according to any one of <1> to <5 >.

<7> A multilayer ceramic capacitor having a ceramic body including the dielectric ceramic according to any one of <1> to <5>.

### DESCRIPTION OF REFERENCE SYMBOLS

10: Dielectric ceramic
12: Crystal grain
14: Grain boundary
20: Ti-rich phase region
30: Sn-rich phase region
110: Multilayer ceramic capacitor
310, 320: External electrode
400: Ceramic body
405: Ceramic layer
410, 402: Internal electrode

1. A dielectric ceramic comprising:
a rutile compound represented by (TiₓSn₁₋ₓ)O₂ as a main constituent; and
Nb, wherein
$$0.4 \leq x \leq 0.6 ,$$
and
in a sectional view the dielectric ceramic includes:
a Ti-rich phase region in which A is 0.55 or more,
a Sn-rich phase region in which B is 0.55 or more,
$$A = ( Ti content ( atom \% ) ) / ( total content of Ti and Sn ( atom \% ) ) ,$$
$$B = ( Sn content ( atom \% ) ) / ( total content of Ti and Sn ( atom \% ) ) ,$$
$$0.005 mol \% \leq y \leq 0.02 mol \% ,$$
$$16 nm \leq {D}_{Ti} \leq 20 nm ,$$
$$15 nm \leq {D}_{Sn} \leq 19 nm ,$$
wherein y (mol %) is a content of Nb with respect to 100 mol % of a content of the rutile compound,
D_{Ti} (nm) is an average size of the Ti-rich phase region, and
D_{Sn} (nm) is an average size of the Sn-rich phase region.

2. The dielectric ceramic according to claim 1, wherein, in the sectional view, the Ti-rich phase region has an area ratio α (%) of 5.50% to 7.10% when the dielectric ceramic excluding pores has an area ratio of 100%.

3. The dielectric ceramic according to claim 2, wherein the area ratio α (%) is 5.50% to 6.80%.

4. The dielectric ceramic according to claim 1, wherein the average size D_{Ti} of the Ti-rich phase region is 16 nm to 18 nm.

5. The dielectric ceramic according to claim 1, wherein the average size D_{Ti} of the Ti-rich phase region is 16 nm to 17 nm.

6. A ceramic capacitor comprising a ceramic body including the dielectric ceramic according to claim 1.

7. The ceramic capacitor according to claim 6, wherein, in the sectional view, the Ti-rich phase region of the dielectric ceramic has an area ratio α (%) of 5.50% to 7.10% when the dielectric ceramic excluding pores has an area ratio of 100%.

8. The ceramic capacitor according to claim 7, wherein the area ratio α (%) of the dielectric ceramic is 5.50% to 6.80%.

9. The ceramic capacitor according to claim 6, wherein the average size D_{Ti} of the Ti-rich phase region of the dielectric ceramic is 16 nm to 18 nm.

10. The ceramic capacitor according to claim 6, wherein the average size D_{Ti} of the Ti-rich phase region of the dielectric ceramic is 16 nm to 17 nm.

11. A multilayer ceramic capacitor comprising a ceramic body including the dielectric ceramic according to claim 1.

12. The multilayer ceramic capacitor according to claim 11, wherein, in the sectional view, the Ti-rich phase region of the dielectric ceramic has an area ratio α (%) of 5.50% to 7.10% when the dielectric ceramic excluding pores has an area ratio of 100%.

13. The multilayer ceramic capacitor according to claim 12, wherein the area ratio α (%) of the dielectric ceramic is 5.50% to 6.80%.

14. The multilayer ceramic capacitor according to claim 11, wherein the average size D_{Ti} of the Ti-rich phase region of the dielectric ceramic is 16 nm to 18 nm.

15. The multilayer ceramic capacitor according to claim 11, wherein the average size D_{Ti} of the Ti-rich phase region of the dielectric ceramic is 16 nm to 17 nm.
